(19) United States
(12) Patent Application Publication
(10) Pub. No.: US 2003/0090480 A1
(43) Pub. Date: May 15, 2003

(54) Disaggregated flat panel display

(75) Inventors: Leslie G. Polgar, Lafayette, CA (US); Ronald S. Cok, Rochester, NY (US); Edward Woodrow, Fairport, NY (US); Kevin Yager, Marion, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/003,832

(22) Filed: Nov. 1, 2001

(51) Int. Cl. G09G 3/32

(52) U.S. Cl. 345/206; 345/82; 345/81

(57) ABSTRACT

A disaggregated color display, including a frame; an OLED display screen mounted in the frame; and an electrical/mechanical interface on the frame for releasably attaching the frame to any one of a plurality of different electronic devices.

### FIELD OF THE INVENTION

The present invention relates to flat panel displays and more particularly to disaggregated organic light emitting diode displays.

### BACKGROUND OF THE INVENTION

Portable electronic devices such as cell phones, pagers, PDAs, global position systems, and electronic cameras having flat-panel displays are becoming more and more common. The quality of the displays on many of these devices is less than pleasing and barely adequate for the purposes. Small-scale (e.g. 10 by 16 cm) high-quality flat-panel color displays using organic light emitting diodes are able to provide high-quality images that are visible in ambient illumination conditions and use less power than previous display technology. These OLED displays have been proposed for use with a variety of portable electronic devices to improve the quality of the display. However, there is a cost associated with providing a high quality display for each of these devices.

Many computer systems include separable components, that is components that can be unplugged from each other and, in some cases, plugged into other systems. Examples include floppy disk drives, keyboards, and CRT displays. Some of these devices utilize a common electrical interface, for example a serial or parallel port available with most computers. However, these devices are generally intended for use with a single system and are not readily applied to a wide variety of computing devices. In particular, although a CRT display device is a part of many computer systems, it is not portable and requires some set up to properly interface with a given system.

Laptop computers also include a variety of components, some of which can be readily removed or replaced, particularly within special docking cradles intended to hold the component. For example, battery packs, Digital Versatile Disk drives, and Compact Disk drives are all removable components available with the IBM Thinkpad laptop computer. However, these components are not intended for use with a multiplicity of different kinds of devices but are restricted in their application to a specific computer.

Memory devices such as CompactFlash™ memory are presently used with multiple devices such as digital cameras, PDAs and personal computers. There are also portable electronic devices that include external peripherals. For example, folding keyboards can be purchased as component peripherals for PDAs. Likewise, special cameras such as the PalmPix from Eastman Kodak can be connected to the Palm PDA. In these cases, however, the components are not compatible with other kinds of electronic devices or even with other PDA from other manufacturers.

There is a need therefore for an improved display that is compatible with a wide variety of portable electronic devices and avoids the expense of redundant displays for each device.

### SUMMARY OF THE INVENTION

The need is met according to the present invention by providing a disaggregated flat panel color display, including a frame; an OLED display screen mounted in the frame; and an electrical/mechanical interface on the frame for releasably attaching the frame to any one of a plurality of different electronic devices. As used herein, a disaggregated display means a display that is detachable from and can be used on a variety of different electronic devices.

### BRIEF DESCRIPTION OF THE DRAWINGS

FIG. 1 is a plan view of a disaggregated display according to the present invention;

FIG. 2 is top view of a disaggregated display according to the present invention;

FIG. 3 is a schematic diagram showing a system including a plurality of electronic devices and a disaggregated display according to the present invention;

FIG. 4 is a perspective view of a disaggregated display used in a digital camera;

FIG. 5 is a schematic block diagram of a disaggregated display according to an alternative embodiment of the present invention;

FIG. 6 is a perspective view of a disaggregated display used in a palm sized computer;

FIG. 7 is a perspective view of a disaggregated display used in a personal digital assistant; and

FIG. 8 is a perspective view of a disaggregated display used in a cell phone.

### DETAILED DESCRIPTION OF THE INVENTION

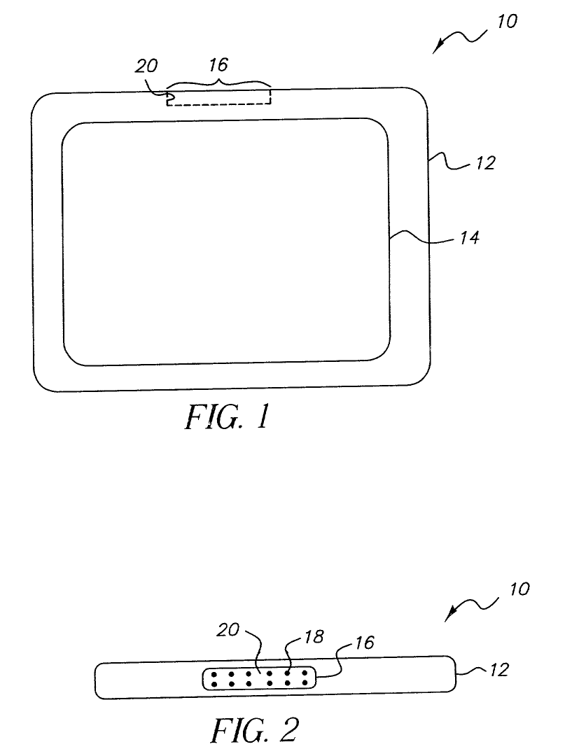

Referring to FIGS. 1 and 2, the disaggregated display 10 according to the present invention includes a frame 12. A color OLED display screen 14 is mounted in the frame. The frame 12 includes an electrical/mechanical interface 16. The electrical/mechanical interface includes a plurality of electrical conductors 18 that that are electrically connected to the display for providing power and drive signals to the OLED display screen 14. The electrical mechanical interface also includes a socket 20 for releasably attaching the frame to any one of a plurality of different electronic devices (not shown). The socket 20 is adapted to receive a complementary plug in an electronic device. The size of the OLED display screen is preferably about 10 by 16 cm, with at least quarter VGA resolution (240×320 pixels) but the actual size and resolution are not critical factors.

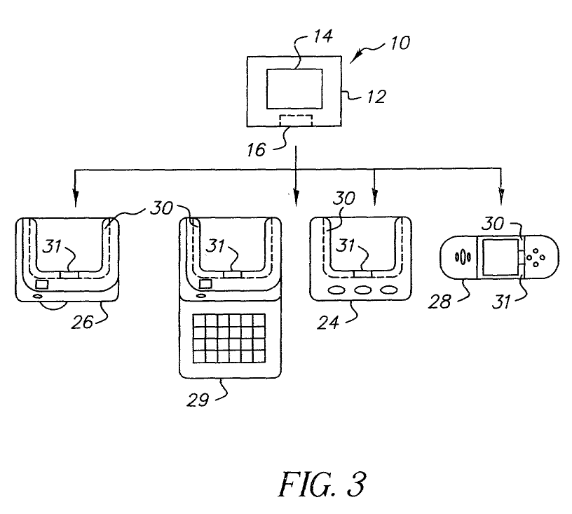

Referring to FIG. 3, a system employing the display according to the present invention is shown. The system includes the disaggregated display 10, and a plurality of different electronic devices. For example, the electronic devices may include, but are not limited to a PDA 24, an electronic camera 26, a cellular telephone 28 and a palm-sized computer 29. Each of the electronic devices 24, 26, 28 and 29 includes an electrical/mechanical interface that is complementary to the electrical mechanical interface socket 16 of the display 10. The electrical, mechanical interface includes, for a example, slot 30 for receiving and mechanically supporting the edges of frame 12 of the disaggregated display 10 and a plug 31 for plugging into socket 20 to make an electrical connection to the electrical components including the OLED display screen 14.

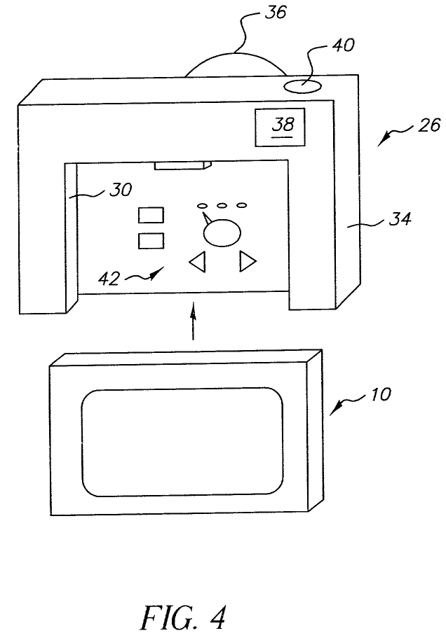

Referring to FIG. 4, an electronic camera 26 for use with the disaggregated display 10, the camera 26 includes a body 34 defining a slot 30 for receiving the disaggregated display 10. The camera includes a taking lens 36, a viewfinder 38, and a shutter release button 40. The camera 26 can also include a user interface 42 including a plurality of buttons that are covered when the display is attached to the camera and can be accessed by a user of the camera when the display is not attached.

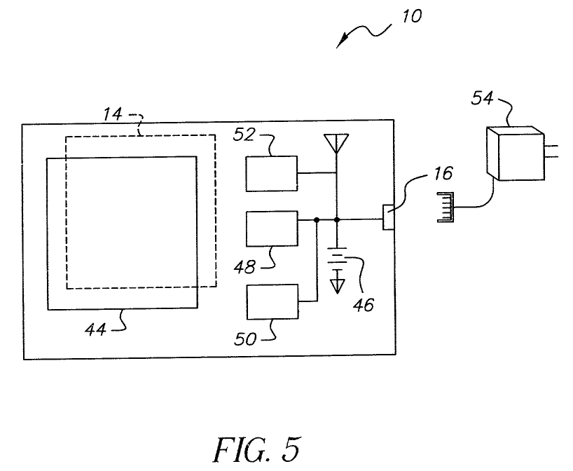

Referring to FIG. 5, in an alternative embodiment of the display 10, the display includes a touch screen 44, a power supply 46, a memory 48 to store data such as image data, and sufficient control electronics 50 such that the display can be used to display captured images when the display is not connected to the camera 10. The display can then be transported, viewed by others, and passed around to a group of people for viewing independently of the original electronic device. For example, the electronic camera 26 might be used by a photographer to capture a scene. The scene can then be displayed on the display 10, detached, and given to others to view.

The display 10 may also include a wireless communication transceiver 52 so that the display can communicate with an electronic device such as the camera 26 even when it is not connected to the device. For example, through the wireless transceiver 52, the display 10 can be used to remotely control the electronic device by displaying a control menu on the display and receiving control inputs from the touch screen 44. Alternatively, the electronic camera 26 can be operated independently of the display 10 to capture images, and the image data transmitted to and displayed by the display 10. The disaggregated flat-panel color display device 10 may also include software to provide display services for data or images stored in an electronic device such as a camera.

The power supply 46 can be any conventional portable power supply such as an alkaline battery, a rechargeable battery such as a NiCad battery, or a fuel cell. A rechargeable battery may be recharged from a power supply in the electronic device, or alternatively from an external battery charger 54.

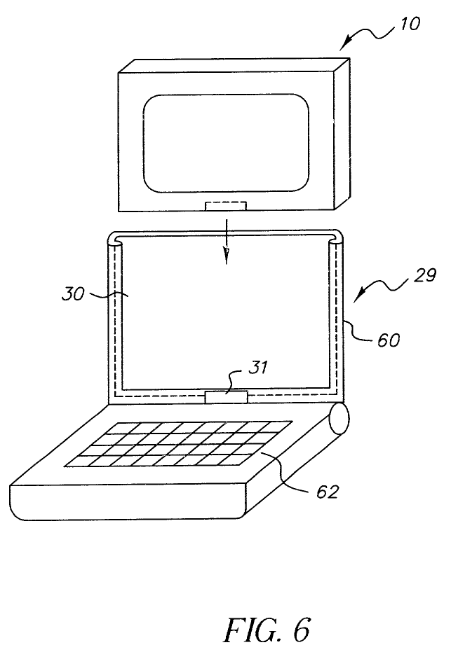

Referring to FIG. 6, a palm sized computer 29 for use with the disaggregated display 10 the computer 29 includes a cover 60 defining a slot 30 for receiving the disaggregated display 10. The computer includes a keypad 62. As described above, the display device may include a touch screen, an independent power supply and a wireless transceiver. In this embodiment, the palm sized computer 29 can be operated remotely with the display 10, either by operating the display from the keyboard, or by operating the computer from the display 10 using the touch screen as a user interface.

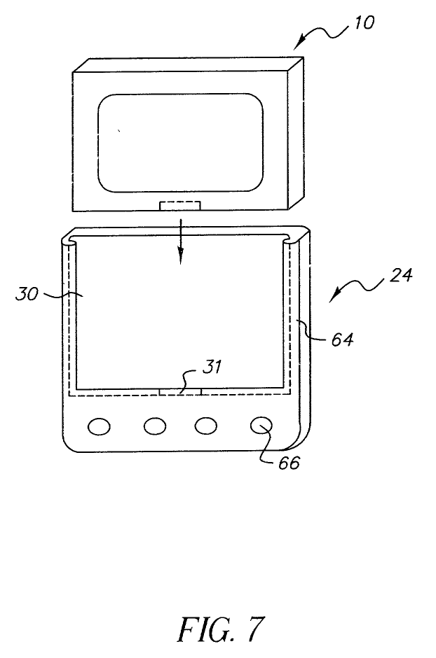

Referring to FIG. 7, a personal digital assistant (PDA) 24 for use with the disaggregated display 10 the PDA 24 includes a body 64 defining a slot 30 for receiving the disaggregated display 10. The PDA 24 includes a simple user interface such as buttons 66. As described above the display 10 may include a touch screen, an independent power supply and a wireless transceiver. In this embodiment, the PDA 24 can be operated remotely from the display 10 using the touch screen 44 as a user interface.

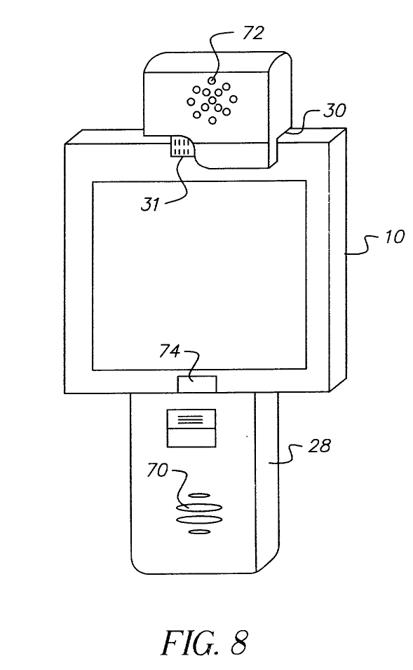

Referring to FIG. 8, a cell phone 28 for use with the disaggregated display 10 defines a slot 30 for receiving the disaggregated display 10, and a latch 74 for releasably holding the display in the slot 30. The cell phone 28 includes a microphone 70 and a speaker 72. As described above the display 10 may include a touch screen, an independent power supply and a wireless transceiver. In this embodiment, the cell phone 28 can be operated remotely from the display 10 using the touch screen 44 as a user interface. As described above with respect to the digital camera, the cell phone 28 may include user interface buttons (not shown) that are hidden when the display is mounted on the cell phone.

Disaggregated displays according to the present invention can be sold independently of the electronic devices, thereby reducing the cost of the electronic devices by sharing the cost of the display with several devices.

The invention has been described in detail with particular reference to certain preferred embodiments thereof, but it will be understood that variations and modifications can be effected within the spirit and scope of the invention.

### Parts List

10 disaggregated display

12 frame

14 OLED display

16 interface

18 electrical conductors

20 socket

24 PDA

26 digital camera

28 cell phone

29 palm-sized computer

30 slot

31 plug

34 camera body

36 taking lens

38 viewfinder

40 shutter release

42 user interface

44 touch screen

46 power supply

48 memory

50 control electronics

52 communications transceiver

54 battery recharger

60 cover

62 keypad

64 body

66 button

70 microphone

72 speaker

74 releasable latch

What is claimed is:

1. A disaggregated flat-panel color display, comprising:
a) a frame;
b) an OLED display screen mounted in the frame; and
c) an electrical/mechanical interface on the frame for releasably attaching the frame to any one of a plurality of different electronic devices.

2. A system of electronic devices, comprising:
a) a plurality of different electronic devices, each having an electrical/mechanical interface; and
b) a disaggregated flat panel color display having,
i) a frame;
ii) an OLED display screen mounted in the frame;
iii) an electrical/mechanical interface on the frame for releasably attaching the frame to the electrical/mechanical interface of the plurality of different electronic devices.

3. The disaggregated flat-panel color display claimed in claim 1, wherein the electrical/mechanical interface is compatible with the Digital Video Interface.

4. The disaggregated flat-panel color display claimed in claim 2, wherein the display is mechanically mounted on an electronic device to make an apparently single component.

5. The disaggregated flat-panel color display claimed in claim 2, wherein the display is mechanically attached to an electronic device through a cable with wires.

6. The system claimed in claim 2, wherein the electronic devices include one or more devices selected from the group of devices comprising a digital camera, a film camera with a digital display, a PDA, a cell phone, a pager, a game, and a portable computer.

7. The disaggregated flat-panel color display claimed in claim 1, wherein the interface is a radio frequency communications interface for communicating with the electronic device.

8. The disaggregated flat-panel color display device claimed in claim 1, further comprising: a power supply and memory to maintain an image on the display when detached from the electronic device.

9. The disaggregated flat-panel color display device claimed in claim 1, further comprising: a touch screen mounted over the OLED display screen for providing an interactive user interface.

10. The disaggregated flat-panel color display device claimed in claim 9, further comprising: a power supply, a memory, and a controller with software to provide imaging review services on the display.

11. The disaggregated flat-panel color display device claimed in claim 10, further comprising: a wireless communications interface for communicating control instructions to the electronic device.

12. The disaggregated flat-panel color display device claimed in claim 9, wherein the display device is adapted to cover controls on the electronic device when the display is attached to the electronic device.

13. The disaggregated flat-panel color display device claimed in claim 1 wherein the electrical interface includes a power interface.

14. The disaggregated flat-panel color display device claimed in claim 13, further comprising a power supply that is recharged from a power supply in the electronic device.

15. The disaggregated flat-panel color display device claimed in claim 8, wherein the power supply is a battery.

16. The disaggregated flat-panel color display device claimed in claim 8, wherein the battery is a rechargeable battery.

17. A disaggregated OLED display.

18. The disaggregated flat-panel color display device claimed in claim 11, further comprising: software to provide display services for images stored in the electronic device.
